(19) United States
(12) Patent Application Publication
(10) Pub. No.: US 2002/0196954 A1
(43) Pub. Date: Dec. 26, 2002

(54) Modeling and fabrication of three-dimensional irregular surfaces for hearing instruments

(76) Inventors: Christopher J. Marxen, Stewartsville, NJ (US); Matthew J. Pietrafita, Belle Meade, NJ (US)

Correspondence Address: Siemens Corporation, Intellectual Property Department, 186 Wood Avenue South, Iselin, NJ, 08830, US

(21) Appl. No.: 09/887,939

(22) Filed: Jun. 22, 2001

(51) Int. Cl. H04R 25/00

(52) U.S. Cl. 381/312; 381/328

(57) ABSTRACT

The design of a shell of a hearing instrument can be optimized by representing it as a virtual object. A digital representation of the ear and the ear canal of the user is obtained used to generate a shell that will precisely fit in the space. Remaining in the virtual domain, the various components and features can be placed and the size, configuration, and dimensions of the shell can then be optimized for performance, fit, and comfort, yet also minimized for aesthetic reasons.

### BACKGROUND OF THE INVENTION

A hearing instrument that resides in the ear, as opposed to a “behind-the-ear” unit, comprises a shell that fits inside the user's ear canal and possibly a portion of the outer ear and houses the components necessary to amplify and convey sound. The various components, such as a microphone, an amplifier, and a receiver (i.e., the loudspeaker), must be positioned properly in the shell to avoid creating feedback, a potential problem in hearing instruments.

Because the ear canal is a relatively small space, it is not an easy task to make a shell that will accommodate the needed components in a workable fashion. Moreover, even after the device has been constructed using the current practice of a creating a silicone mold replicating the user's ear, the outer shell often requires that it be remade anew to resolve fit issues.

### BRIEF DESCRIPTION OF THE DRAWINGS

FIG. 1 is a partial cross-sectional drawing of the outer ear and the ear canal, where the ear canal contains a hearing instrument;

FIG. 2 is a partial cross-sectional drawing of the outer ear and the ear canal illustrating a variety of hearing instrument configurations;

FIG. 3 is a cross-sectional drawing of a hearing device;

FIG. 4 is a flow chart of a modeling process for a hearing instrument; and

FIG. 5 is a flow chart of a process for modifying the dimensions of the shell of a hearing instrument.

### DESCRIPTION OF THE INVENTION

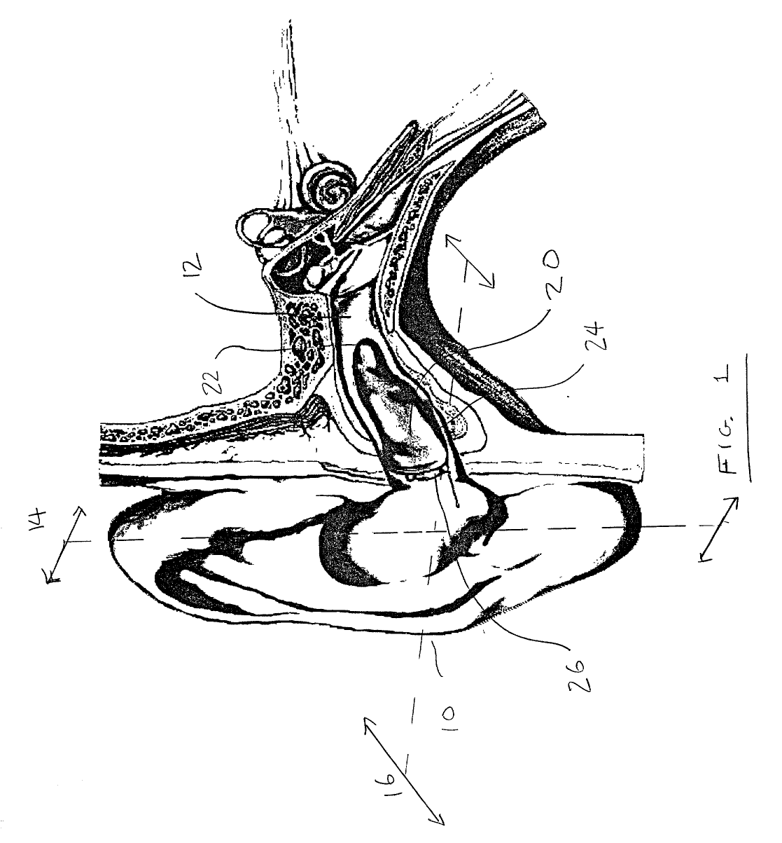

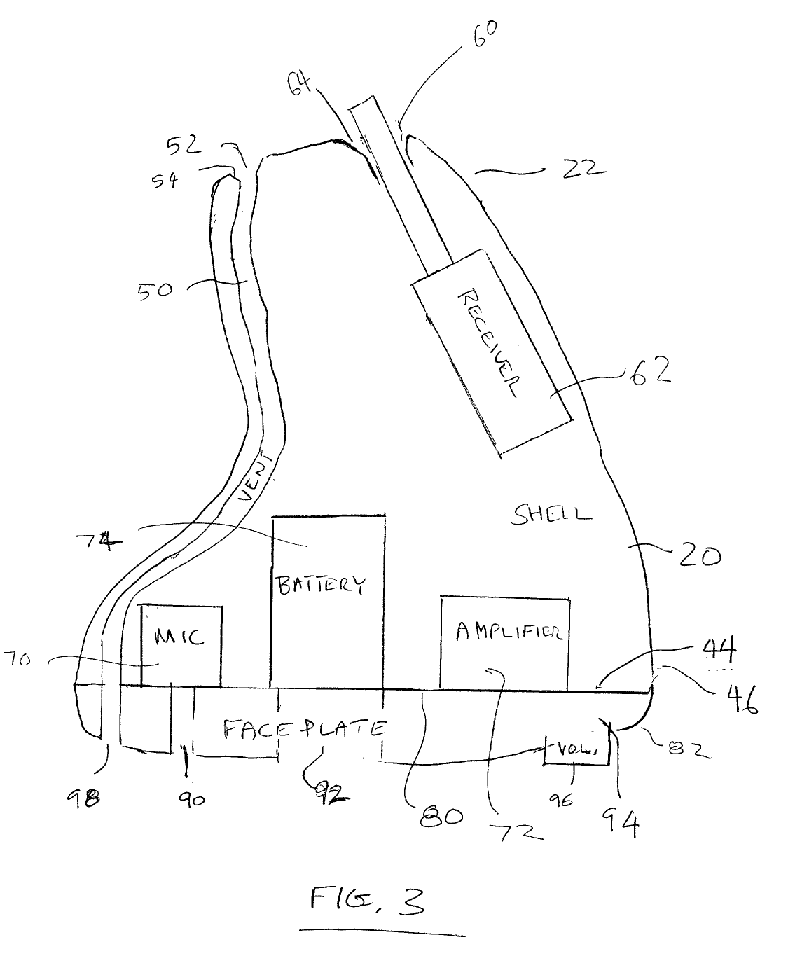

By virtually modeling the contours of the outer ear 10 and the ear canal 12 of the user (FIG. 1), a conforming hearing instrument shell 20 can be produced. Remaining in the virtual domain, the various structural features (e.g., vents, openings, the faceplate) and components (e.g., microphone, battery, amplifier, receiver) of a hearing instrument, illustrated in FIG. 3, can be inserted or located on the shell. By doing this in software, it is relatively easy to determine whether an actual shell of the same dimensions can accommodate the desired structural features and components and still function properly, yet result in the smallest possible package. In the event that a given shell size cannot accept the required components, the shell dimensions and/or its components and structural features and their dimensions can be adjusted until a solution is reached. For example, smaller components or structural features might be used or the shell could be enlarged.

The ability to modify the virtual shell and its components and structural features permits the creation of a custom hearing instrument, where the fit, insertion, and performance can be optimized for each user. A change can be made to the entire shell, a small area, or a segment, such as the canal tip 22, the acoustic sealing area 24, or the outer or apex portion 26, or to internal and external components and structural features before committing to a physical device that would have to be extensively reworked or discarded if the instrument did not fit or operate properly.

Further modifications may be made in the virtual domain to allow for anticipated fit concerns. These may be based on the user's own history or the histories of other users with ear canals and outer ears having similar shapes and dimensions. Finally, in the event a unit does not fit, slight modifications can be made with a high degree of accuracy and precision to a virtual representation of the shell derived directly from the original unit and a wholly new instrument can be constructed, alleviating the need to again obtain another model of the user's ear canal and outer ear.

Acquiring the Contours of the Ear Canal

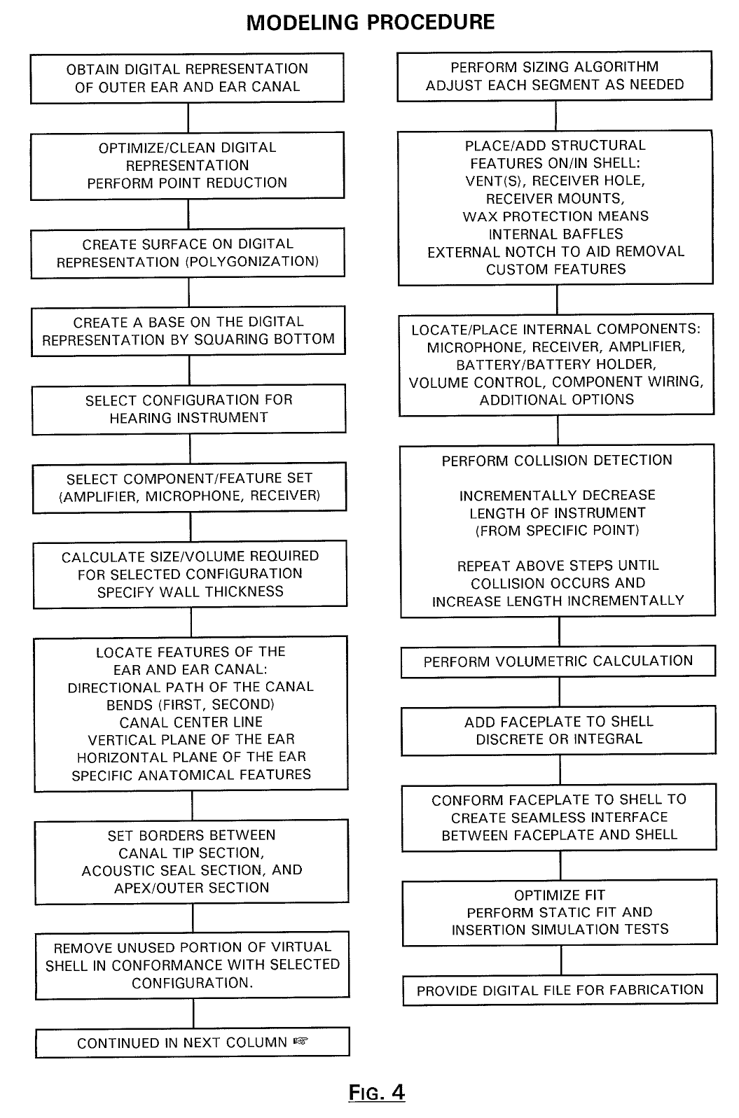

To begin the process, shown in the flow chart of FIG. 4, a virtual or digital representation defining the precise contours of some portion of the ear canal, and perhaps the outer ear, is obtained. Since the canal is not rigid and its shape and dimensions can change as the jaw moves as one speaks or eats, digital representations for different positions of the jaw may be acquired. These variations can be factored in when the shell is initially sized and also when tested for fit in the ear and the ear canal.

A digital representation may be obtained by scanning the subject's outer ear and ear canal directly, or by scanning an impression created from a compound inserted into the ear (e.g., silicone), or by some other suitable means. The data resulting from the scan is commonly referred to as a point cloud, i.e., a collection of points having the appearance of a cloud.

Due to potential irregularities in the scanning process, the point cloud may include invalid data such as a point not lying on the surface, sometimes referred to as an outlier. Commercially-available software may be used to detect and discard such unwanted information. Also, the data may have irregularities introduced during the scanning process, such as holes, dimples, discontinuities, or noise, that can be corrected using commercially-available software.

The number of points constituting the point cloud may also be reduced. For example, while a line need be defined by only two endpoints, the point cloud may contain many points between the endpoints. To lessen the overhead demands required to process the images, these additional non-critical points can be eliminated.

Once the point cloud image has been cleaned, a “skin” is created. This may be accomplished by connecting the points to create polygons; the entire process may be referred to as “polygonization,” for which software is commercially-available. Although any polygon may be used, triangles provide sufficient flexibility and interconnectability. It may again be necessary to clean up the image, as the polygonization process may itself have introduced holes, dimples, discontinuities, or noise.

The data now represents a virtual shell conforming to the ear canal and perhaps a portion of the outer ear. A base 44 is created by squaring off the wider portion 46 of the shell 20 oriented towards the outer ear. The data may be presented as an STL (stereo lithography) file or some other format suitable for a rapid prototyping or direct manufacture device. Instead of the discrete steps discussed above, the scanned data could be converted directly to an output file such as STL.

Initial Values

Having acquired a digital representation of the ear canal and perhaps a portion of the surrounding outer ear structure, the hearing instrument is now built in the virtual sense. To begin, there are several configurations or models of hearing instrument that will fit in the ear, in part varying in the amount of space occupied in the ear.

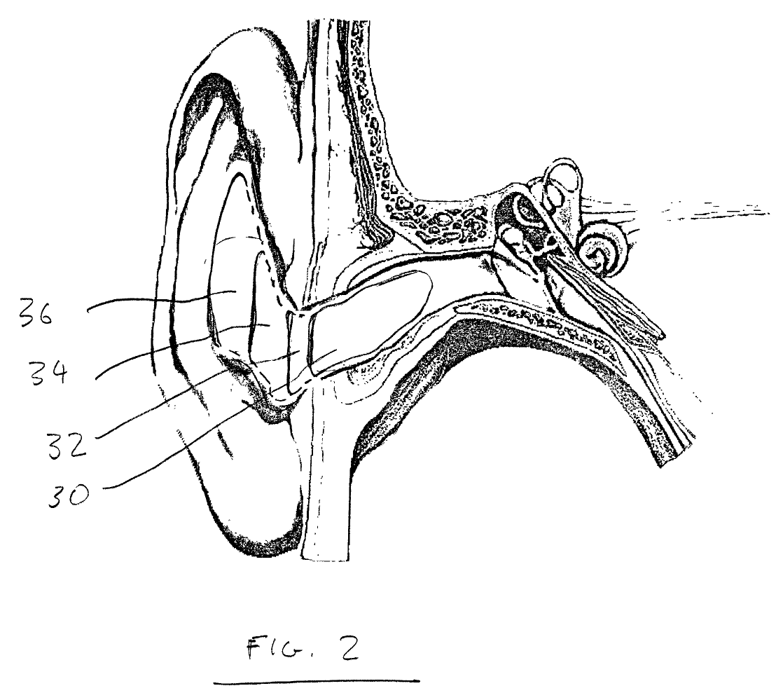

As illustrated in FIG. 2, the instrument may reside completely within the ear canal (30), extending partially out of the canal (32), and then progressively occupying more of the outer ear (34 and 36). In the hearing instrument industry, these configurations are referred to variously as “CIC”—completely in the canal, “ITC”—in the canal, and “ITE”—in the ear. These are only a few of many possible hearing instrument configurations. Other sizes and configurations, occupying some portion of the outer ear and/or the ear canal to a greater or a lesser degree are certainly possible and contemplated.

To continue the process of designing a hearing instrument, a configuration and a desired level of performance are selected, which in turn dictates some or all of the following information:

electronic components: amplifier, microphone, receiver, battery

faceplate configuration

vents (or no vent)

internal and external structural features

other options

In view of the foregoing parameters, the size and volume of the shell required for the selected configuration is calculated. At this time, the thickness of the wall of the shell may be specified.

Feature Recognition

As a preliminary matter, the location of certain aspects or features of the ear and the ear canal can be determined with respect to the shell. These aspects may include:

directional path of the ear canal

bends in the ear canal

centerline of the ear canal

the vertical plane of the ear

horizontal plane of the ear (with respect to the centerline)

specific anatomical features (e.g., tragus, anti-tragus, helix)

anatomical irregularities (e.g., mole, mastoid operation)

The direction of the canal is important as the sound produced by the instrument must be directed towards the ear drum. Further, the ear canal may have one or more bends. Any device inserted into the ear and residing in the vicinity of such bends will itself require conforming bends which will aid in the device's ability to remain in the canal and the insertion of the device into the ear. Also, the centerline of the ear canal can be determined and may be used to position the receiver hole 60, where sound exits the instrument. Optionally, a fillet 64 may be added to the receiver hole 60 on the outside of the shell.

In the case of larger hearing instruments occupying a greater portion of the outer ear, it may also be helpful to determine the location of the vertical plane 14 of the ear, transverse to the centerline of the ear canal, to define an outer boundary for the shell. Finally, if directional microphone technology is specified, the location of the horizontal plane 16 can also be determined.

Additionally, it might be useful to identify specific anatomical features. These may include structural aspects of the outer ear, such as the tragus, the anti-tragus, and the helix. Also included are irregularities such as moles and physical changes due to a mastoid operation. Such an identification could performed with pattern recognition technology.

As noted previously, the shell can be divided into segments, roughly corresponding to their function and position in the ear. This provides a logical way of applying modifications to distinct sections of the shell. The canal tip 22 (FIG. 1) extends furthest into the ear canal. Next, there is the acoustic seal segment 24, which provides a relatively sound-proof barrier where the shell meets the wall of the ear canal. Finally, there is an apex or outer segment 26. The division of the shell into three segments is purely arbitrary; the hearing instrument shell could have been divided into two, four, or some other number of sections, or no divisions at all.

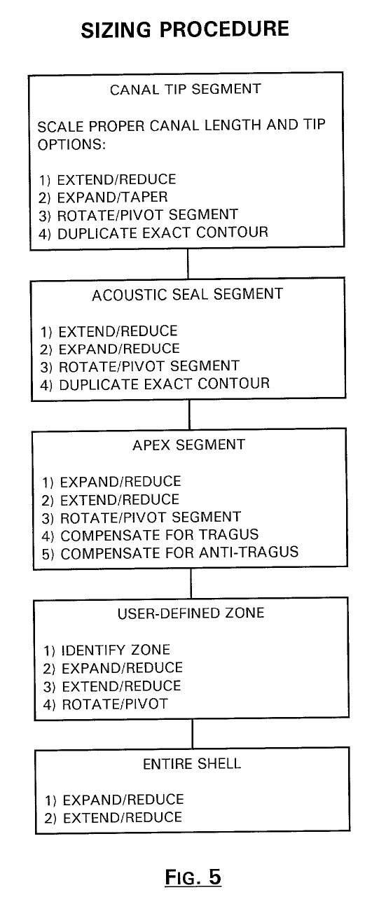

Having made the foregoing designation, the unused portion of the shell can be discarded. Using the algorithm set forth in FIG. 5, each segment may be adjusted. Adjustments of this nature may be made to account for historical indicia of difficult fit or acoustic sealing problems, based on the current user or others, not resolved with an exactly conforming shell. The adjustments may be specified as percentages of dimensions and parameters, or in units, e.g., inches, millimeters, degrees, etc. Alternatively, any user-defined zone or the entire shell can be modified in the same fashion. Finally, any or all of the segments may be sized to the exact dimensions and contours of the ear and the ear canal.

Various operations are available under the procedure outlined in FIG. 5. For example, any given object can be expanded or reduced, extended or shortened, tapered, or rotated or pivoted about an axis. Although the capability may exist in a computer-aided design package to perform all of these operations on any segment of the shell, in actual practice, only a subset of these capabilities will be applied to a particular segment of the instrument.

A typical structural feature of the shell 20 a hearing instrument is a vent 50, running the length of the shell, and a vent hole 52 in the canal tip segment 22. The vent 50 serves at least two functions. First, it helps prevent occlusion, an undesirable emphasis of low frequencies, by allowing a portion of the sound to pass through a channel connecting the ear drum to the outside. Second, it may also function as a pressure relief. The path of the vent may be adjusted to allow clearance for other components and a fillet 54 may be added to the vent hole.

The canal tip segment 22 would also have a receiver hole 60 for the receiver 62 that generates the sound transmitted to the ear drum. If desired, a wax protection device (not shown), such as a removable cap, may also be positioned over the vent and receiver holes 52 and 60. In such a case, the end of the canal tip segment 22 may need to be flattened into a plateau to provide a mount for the wax protection device. Alternatively, the receiver and vent holes 60 and 52 can be protected by creating a depression (not shown) at the end of the canal tip segment 22 that recesses the openings.

Component Location/Positioning

Next, the internal components of the hearing instrument (e.g., the microphone 70, amplifier 72, battery 74, and receiver 62), as illustrated in FIG. 3, can be positioned. Using commercially-available software, a collision detection operation is performed to insure that the components will fit in the available volume of the shell and in their assigned locations. The initial location of these components may be previously specified or determined by a software package that seeks an optimum placement. Should the collision detection function indicate that the selected position would result in a collision, the components can be repositioned or resized, or the shell can be lengthened.

The collision detection test is now run. Because of the potential for feedback, certain components (e.g., the receiver) may require imaginary guard or buffer zones which may not be compromised. Thus, a collision may occur between the buffer zone and a solid object, such as an amplifier or the internal wall of the shell. Assuming no collision, the shell may be shortened incrementally. The collision detection test is again run and the shell shortened, the cycle repeating until a collision occurs. The shell length would revert to that prior to the last incremental decrease.

While the shell may be shortened from any reference point, it is desirable to perform this function from the faceplate end 46 of the shell 20. During the collision detection process, the faceplate components are positioned on an imaginary faceplate plane 80, corresponding to the inside surface of the faceplate 42, which moves towards or away from the canal tip segment 22 as necessary to decrease or increase the volume of the shell.

At this point, or perhaps at some other juncture, a determination of the volume of the shell may be made. This information may be collected and then used as an initial value for similar shell configurations.

Faceplate

The faceplate 42 of the instrument may be used to support some of the internal components, such as the microphone 70, the battery 74, and the amplifier 72. The faceplate 42 can be a separate structure or it may fashioned as an integral part of the shell 20. In either case, the faceplate 42 is modeled as a virtual representation and then aligned with the shell 20.

The dimensions of the faceplate 42 in the imaginary plane 80 are trimmed or cut to the width of the shell 20. The interface between the faceplate 42 and the shell 20 could also be blended, i.e., smoothly merged together, to avoid the appearance or creation of a seam during the fabrication process. Additionally, a bevel or a rounded edge 82 may be added to the edge of the faceplate to further improve the interface and provide an aesthetically-pleasing appearance. Openings 90, 92, 94, and 98 can be provided in the faceplate 42 for the microphone 70, battery replacement, a volume control 96, a vent if applicable, and any other desired options.

One or more notches, handles, or other removal enhancement devices (not shown) may be placed on the surface of the shell. They will assist the wearer in removing the hearing instrument from the ear. If desired, identifiers such as serial numbers (not shown) can be placed on internal or external surfaces of the instrument.

Comparing and Optimizing Fit

The hearing instrument is now complete. Further operations to optimize fit, comfort, and appearance may now be performed. For example, the virtual shell may be compared in a superposition with the virtual ear canal and outer ear to confirm that the shell when fabricated will not be larger than the available space. Also, a dynamic insertion test, simulating the insertion of the virtual instrument into the virtual ear canal may be performed to identify any interference and insure ease of insertion. If instruments are being prepared for both ears, they may be compared to insure that they are roughly the same in appearance.

The resulting output file, such as an STL file, is provided to a rapid prototyping or direct manufacturing device that fabricates the physical shell. A rapid prototyping or direct manufacturing system that uses selective laser sintering can provide the required degree of precision to fabricate the shell.

If a duplicate device is needed, it can be made without the need to once again acquire the contours of the user's ear and ear canal. If the user complains that a device does not fit properly or results in discomfort, any segment or portion of the shell can be adjusted, expanded, tapered, reduced, or otherwise manipulated with a fair degree of precision. Further, if the canal tip segment is aimed in the wrong direction, the tip of the segment can be pivoted to the desired orientation.

The steps shown in FIG. 4, as well their order, are illustrative of some of the procedures used to model and optimize a hearing instrument. Some of these steps may be omitted and others could be added, and the order of these steps could be changed to suit the application. This similarly applies to the procedure shown in FIG. 5.

The foregoing discussion refers to hearing instruments. The same process and apparatus may be used for the fabrication of any other device inserted in the ear or any other opening requiring a conforming fit.

what is claimed is:

1. A method for optimizing the fit of a shell of an in-the-ear hearing apparatus comprising at least one component or structural feature, comprising the steps of:
obtaining a digital representation of a portion of the ear canal and/or a portion of the outer ear;
creating a digital representation of a shell conforming to the digital representation of the ear canal and the outer ear, the step of creating a digital representation of a shell comprising the step of creating at least a digital representation of an outer surface of the shell; and
modifying
at least one physical dimension of at least a portion of the digital representation of the shell; and/or
the dimensions and/or position of at least one component or structural feature.

2. A method as set forth in claim 1, where the step of creating a digital representation of the shell comprises the step of reducing the number of points in the digital representation of the shell.

3. A method as set forth in claim 1, where the step of modifying at least one physical dimension of at least a portion of the digital representation of the shell comprises the step of expanding, reducing, tapering, or pivoting at least a portion of the shell.

4. A method as set forth in claim 1, where the step of modifying at least one physical dimension of at least a portion of the digital representation of the shell comprises the step of dividing the shell into a plurality of segments and expanding, reducing, tapering, or pivoting one or more of the segments.

5. A method as set forth in claim 1, where the step of modifying at least one physical dimension of at least a portion of the digital representation of the shell comprises the step of compensating for anatomical irregularities in the outer ear or the ear canal.

6. A method as set forth in claim 1, where the step of modifying at least one physical dimension of at least a portion of the digital representation of the shell comprises the step of creating a seamless interface between the shell and a faceplate.

7. A method as set forth in claim 1, where the step of creating a digital representation of the shell comprises the step of creating a faceplate integral with the shell.

8. A method as set forth in claim 1, further comprising the step of positioning one or more components or structural features in or on the shell.

9. A method as set forth in claim 8, further comprising the steps of:
reducing the volume of the shell incrementally until at least one of the components in the shell collides with another component or the internal wall of the shell; and
enlarging the volume of the shell until the collision is alleviated.

10. A method as set forth in claim 1, further comprising the step of superpositioning the shell in the ear canal and in the outer ear as applicable.

11. A method as set forth in claim 1, further comprising the step of simulating the insertion of the shell into the outer ear and the ear canal.

12. A method as set forth in claim 1, further comprising the step of fabricating a hearing instrument by direct manufacture.

13. A method as set forth in claim 1, further comprising the steps of:
fabricating a hearing instrument from the digital representation of the shell;
fitting the instrument in the user's ear;
generating an identical virtual apparatus; and
in response to the fitting of the instrument in the user's ear, further modifying at least a portion of the shell to optimize the fit, comfort, and/or performance of the apparatus.

14. A method as set forth in claim 1, further comprising the steps of:
generating an identical virtual apparatus; and
fabricating a hearing instrument;

15. A method as set forth in claim 1, further comprising the step of applying an identifier to the shell.

16. A method for optimizing the fit of a digital representation of an in-the-ear hearing apparatus comprising a shell and at least one component or structural feature, comprising the steps of:
modifying at least one physical dimension of at least a portion of the shell; and/or
modifying the dimensions and/or position of at least one component or structural feature.

17. An apparatus for optimizing the fit of a shell of an in-the-ear hearing instrument comprising at least one component or structural feature, comprising:
a scanner for obtaining a digital representation of a portion of the ear canal and optionally a portion of the outer ear; and
a processor for creating a digital representation of the shell that conforms to the scanned digital representation of the ear canal and the outer ear as applicable, the processor comprising
means for creating at least a digital representation of the shell; and
means for modifying
at least one physical dimension of at least a portion of the digital representation of the shell; and/or
the dimensions and/or position of at least one component or structural feature.

18. An apparatus as set forth in claim 17, where the processor comprises means for reducing the number of points in the digital representation of the shell.

19. An apparatus as set forth in claim 17, where the processor comprises means for expanding, reducing, tapering, or pivoting at least a portion of the shell.

20. An apparatus as set forth in claim 17, where the means modifying at least one physical dimension of at least a portion of the digital representation of the shell comprises means for dividing the shell into a plurality of segments and expanding, reducing, tapering, or pivoting one or more of the segments.

21. An apparatus as set forth in claim 17, further comprising means for fabricating a hearing instrument by rapid prototyping or direct manufacture.
